(19) United States
(12) Patent Application Publication
(10) Pub. No.: US 2013/0026858 A1
(43) Pub. Date: Jan. 31, 2013

(54) VOICE COIL MOTOR AND LENS MODULE

(71) Applicant: SHUN-FAN CHIANG, Tu-Cheng (TW)

(72) Inventor: SHUN-FAN CHIANG, Tu-Cheng (TW)

(73) Assignee: HON HAI PRECISION INDUSTRY CO., LTD., Tu-Cheng (TW)

(21) Appl. No.: 13/335,962

(22) Filed: Dec. 23, 2011

(30) Foreign Application Priority Data
Jul. 27, 2011 (TW) 100126653

(51) Int. Cl. H02K 41/03

(52) U.S. Cl. 310/12.16

(57) ABSTRACT

A voice coil motor (VCM) includes a case, a lower plate, a lens holder, a coil, a magnet assembly, and an elastic sheet. The case includes an upper plate and sidewalls extending from edges of the upper plate. Each sidewall includes an inner surface. The lower plate is positioned at one end of the sidewalls and opposite to the upper plate. The lens holder is received in the case. The coil is circled around the lens holder. The magnet assembly consists of a first magnet and a second magnet, the first magnet and the second magnet are plate shaped and respectively positioned on the inner surfaces of opposite two of the sidewalls. The elastic sheet is connected between the lower plate and the lens holder.

### BACKGROUND

1. Technical Field

The present disclosure relates to voice coil motors (VCMs) and, particularly, to a VCM with a simple structure and a lens module using the VCM.

2. Description of Related Art

VCMs are used in lens modules for driving the lens barrels to move. Each VCM generally includes a coil sleeved around the lens barrel and a magnet surrounding the coil. The magnet is one of the essential elements of the VCM. It is hard to simplify the structure or reduce the size of the magnet to reduce the cost of the VCM.

Therefore, it is desirable to provide a VCM that can overcome the limitations described.

### BRIEF DESCRIPTION OF THE DRAWINGS

FIG. 1 is an isometric, exploded, and schematic view of a VCM in accordance with an exemplary embodiment.

FIG. 2 is similar to FIG. 1, but viewed from another angle.

FIG. 3 is an assembled view of the VCM of FIG. 1.

FIG. 4 is a cross-sectional view taken along a line IV-IV of FIG. 3.

FIG. 5 is an assembled view of a lens module using the VCM of FIG. 1.

### DETAILED DESCRIPTION

Embodiments of the disclosure will now be described in detail, with reference to the accompanying drawings.

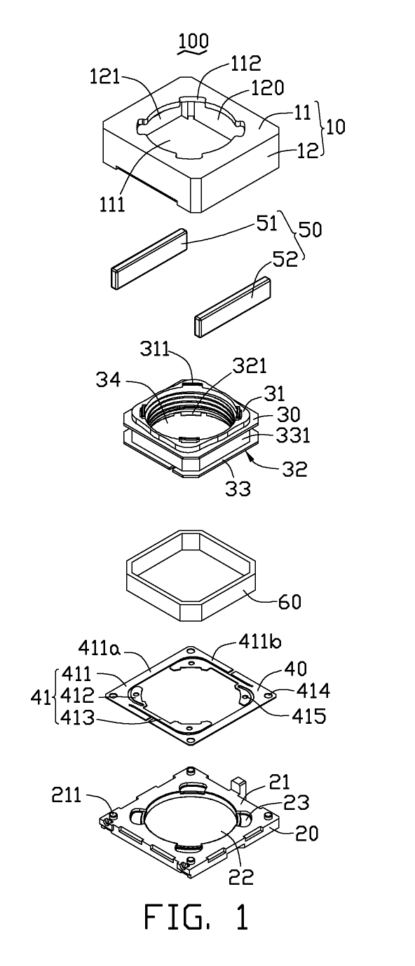

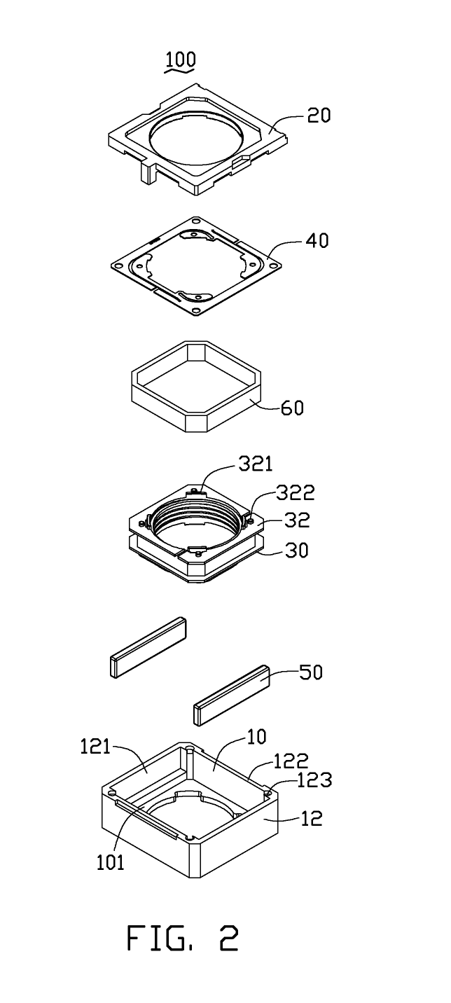

FIGS. 1-2, a voice coil motor (VCM) 100, according to an exemplary embodiment, includes a case 10, a lower plate 20, a lens holder 30, an elastic sheet 40, a magnet assembly 50, and a coil 60.

The case 10 includes an upper plate 11 and four sidewalls 12 perpendicularly extending from four peripheral edges of the upper plate 11. The upper plate 11 and the sidewalls 12 cooperatively define a receiving room 101 for receiving the lens holder 30, the magnet assembly 50, and the coil 60. The upper plate 11 defines a first through hole 111 and a number of guiding holes 112 communicating with the first through hole 111. The first through hole 111 is substantially positioned at a central portion of the upper plate 11, and the guiding holes 112 are equidistantly arranged around the first through hole 111. Each of the sidewalls 120 includes an inner surface 120. Two opposite sidewalls 12 each define a first receiving recess 121 on its inner surface 120. The four sidewalls 12 cooperatively form a lower surface 122 facing away from the upper plate 11. A number of positioning holes 123 are defined in the lower surface 122, substantially at corners of the lower surface 122. In this embodiment, there are four guiding holes 112, and four positioning holes 123.

The lower plate 20 is square-shaped, and includes an upper surface 21. A number of first positioning poles 211 corresponding to the positioning holes 123 project from the upper surface 21, substantially at the corners of the lower plate 20. The lower plate 20 defines a second through hole 22, substantially at a central portion of the lower plate 20. The lower plate 20 further defines a number of guiding recesses 23 on the upper surface 21. The guiding recesses 23 communicate and are equidistantly arranged around the second through hole 22. In this embodiment, there are four first positioning poles 211, and four guiding recesses 23.

The lens holder 30 has a cubic configuration, and includes a top surface 31, a bottom surface 32, and a side surface 33 interconnecting the top surface 31 and the bottom surface 32. A screw hole 34 is defined through the top surface 31 and the bottom surface 32, substantially at the center of the lens barrel 30. A number of first guiding portions 311 protrude from the top surface 31 and are equidistantly arranged around the screw hole 34. A number of second guiding portions 321 protrude from the bottom surface 32 and are equidistantly arranged around the screw hole 34. A number of second positioning poles 322 extend downward from the bottom surface 32, substantially at corners of the bottom surface 32. The lens holder 30 defines a second receiving recess 331 in the side surface 33. The second receiving recess 331 surrounds the lens holder 30. In this embodiment, there are four the first and second guiding portions 311, 321, and four second positioning poles 322.

The elastic sheet 40 can be formed by punching and are made of steel. The elastic sheet 40 is square-shaped and includes two spring portions 41 with the same structure. Each of the spring portions 41 includes an outer portion 411, two inner portions 412, and a connection portion 413 connected between the outer portion 411 and the inner portion 412. The outer portion 411 is substantially U-shaped and includes a first section 411a and two second sections 411b perpendicularly positioned at two ends of the first section 411a. One end of the connection portion 413 is connected to a corner of the outer portion 411 and another end extends out of the outer portion 411 along the second sections 411b. One of the inner portions 412 is connected to an end of the connection portion 413, and is positioned at a corner of the outer portion 411. The other inner portion 412 is connected to another end of the connection portion 413, and is positioned at a corner of another spring portion 41. Each of the outer portions 411 defines a number of first fixing holes 414, substantially at corners of the outer portion 411. Each of the inner portions 412 defines a second fixing hole 415. In this embodiment, two first fixing holes 414 are respectively positioned at two corners of each outer portion 411.

The magnet assembly 50 consists of a first magnet 51 and a second magnet 52. The first magnet 51 and the second magnet 52 are plate shaped, and respectively received in the two first receiving recesses 121. The coil 60 is circled around the lens holder 30 and received in the second receiving recess 331. One end of the coil 60 is connected to one of the spring portions 41, and another end of the coil is connected to another spring portion 41. Therefore, the current can flow to the coil 60 through the elastic sheet 40.

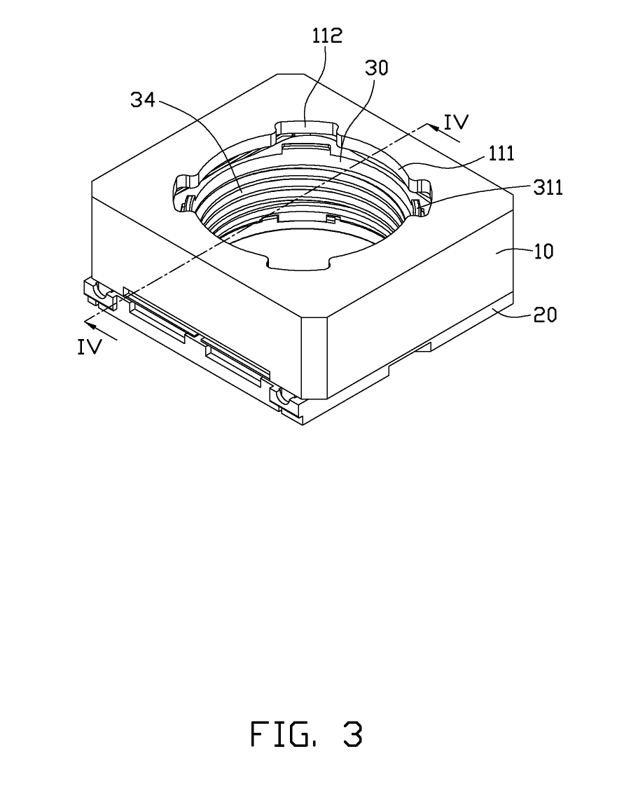

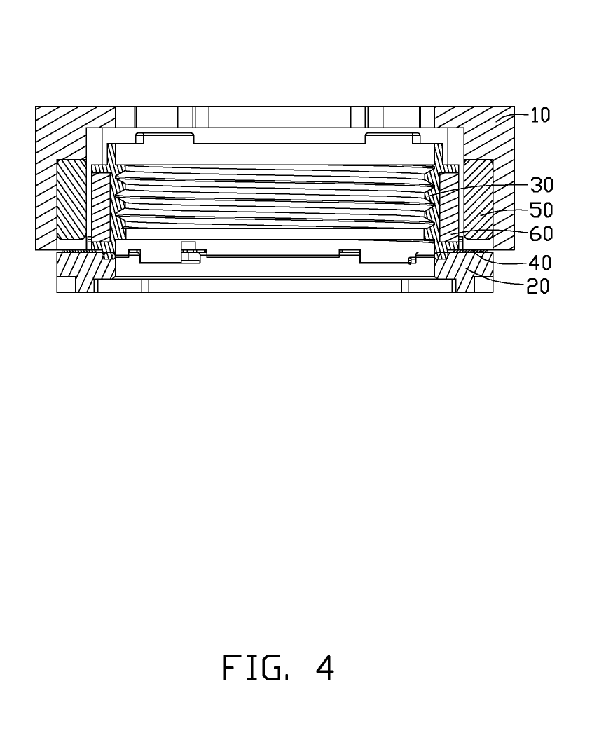

FIGS. 3-4, in assembly, the elastic sheet 40 is interconnected with the lower plate 20 and the lens holder 30. The first fixing holes 414 are sleeved on the first positioning poles 211, and the second fixing holes 415 are sleeved on the second positioning poles 322. The first positioning poles 211 and the second positioning poles 322 are firmly connected to the elastic sheet 40 with glue. The case 10 is covered on the lens holder 30 and is positioned on the lower plate 20. The first positioning poles 211 are received in the positioning holes 123. The first magnet 51 and the second magnet 52 are opposite to each other, and face the coil 60.

During the focusing process, the coil 60 circling the lens holder 30 is supplied with current via the two spring portions 41. The coil 60 generates a magnet field according to a principle of electromagnetic induction. The lens holder 30 is driven to move along the optical axis by a magnetic force between the coil 60 and the magnet assembly 50. The first guiding portions 311 and the second guiding portions 321 of the lens holder 30 are moved up and down in the guiding holes 112 of the upper plate 11 and the guiding recess 23 of the lower plate 20 accordingly. Although the magnet assembly 50 consists of two plated magnets, the VCM 100 works well. Further more, the focusing accuracy of the VCM 100 will not be adversely affected.

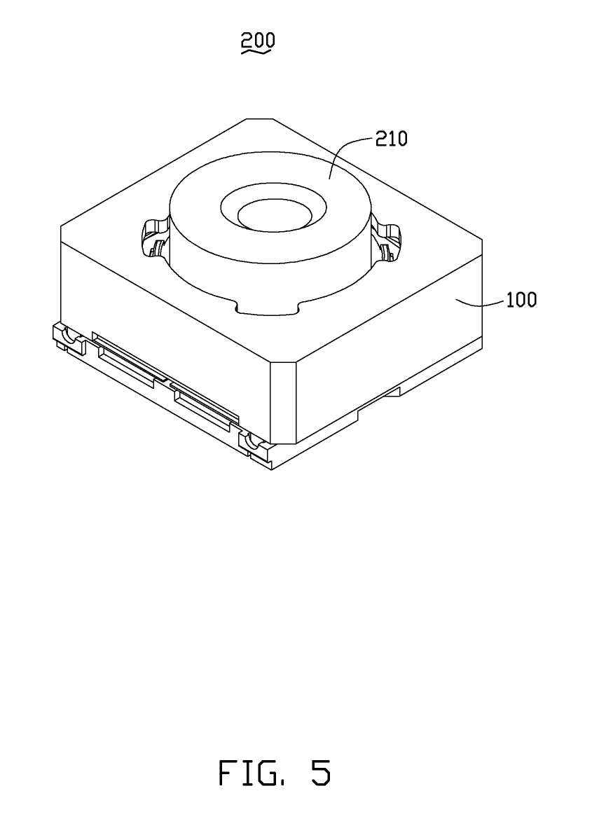

FIG. 5, a lens module 200, according to an exemplary embodiment, includes the VCM 100 and a lens 210. The lens 210 is screwed in the screw hole 34 of the lens holder 30.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A voice coil motor (VCM), comprising:
a case comprising an upper plate and sidewalls extending from edges of the upper plate, the sidewalls comprising two opposite sidewalls, each sidewall comprising an inner surface;
a lower plate positioned at one end of the sidewalls and opposite to the upper plate;
a lens holder received in the case;
a coil circling around the lens holder;
a magnet assembly consisting of a first magnet and a second magnet, the first magnet and the second magnet being plate shaped and respectively positioned on the inner surfaces of the two opposite sidewalls; and
an elastic sheet connecting between the lower plate and the lens holder.

2. The VCM of claim 1, wherein the two opposite sidewalls each define a first receiving recess on the inner surface thereof, the first magnet and the second magnet are received in the first receiving recesses respectively.

3. The VCM of claim 2, wherein the lens holder comprises a top surface, a bottom surface, and a side surface interconnected the top surface and the bottom surface; the lens holder defines a second receiving recess in the side surface, the second receiving recess surrounds the lens holder, the coil is received in the second receiving recess.

4. The VCM of claim 3, wherein the elastic sheet comprises two spring portions, each of the spring portions comprises an outer portion and two inner portions connected to the outer portion, the outer portion is connected to the lower plate, the inner portions are connected to the lens holder.

5. The VCM of claim 4, wherein each outer portions defines a plurality of first fixing holes, each inner portions defines a second fixing hole, the lower plate comprises an upper surface and a plurality of first positioning poles extending upwards from the upper surface, the lens holder comprises a bottom surface and a plurality of second positioning poles extending downwards from the bottom surface, each of the first positioning poles is received in a respective one of the first fixing holes, each of the second positioning poles are received in a respective one of the second fixing holes.

6. The VCM of claim 5, wherein the casing comprises a lower surface at one end of the sidewalls, the casing defines a number of positioning holes in the lower surface, each of the first positioning poles are received in a respective one of the positioning holes.

7. The VCM of claim 5, wherein the upper plate defines a first through hole and a plurality of guiding holes communicating with the first through hole; the lower plate defines a second through hole and a plurality of guiding recesses communicating with the second through hole; the lens holder comprises a plurality of first guiding portions protruding from the top surface, and a plurality of second guiding portions protruding from the bottom surface; the first guiding portions are coupled with the guiding holes, the second guiding portions are coupled with the guiding recesses.

8. The VCM of claim 4, wherein one end of the coil is connected to one of the spring portions, and another end of the coil is connected to the other spring portion.

9. A lens module, comprising:
a voice coil motor (VCM), comprising:
a case comprising an upper plate and sidewalls extending from edges of the upper plate, the sidewalls comprising two opposite sidewalls, each sidewall comprising an inner surface;
a lower plate positioned at one end of the sidewalls and opposite to the upper plate;
a lens holder received in the casing, the lens holder comprising a top surface and a bottom surface, the lens holder defining a screw hole extending all the way through the top surface and the bottom surface;
a coil circling around the lens holder;
a magnet assembly consisting of a first magnet and a second magnet, the first magnet and the second magnet being plate shaped and respectively positioned on the inner surfaces of the two opposite sidewalls; and
an elastic sheet connecting between the lower plate and the lens holder; and a lens screwed in the screw hole of the lens holder.
